(19) United States
(12) Patent Application Publication
(10) Pub. No.: US 2008/0139981 A1
(43) Pub. Date: Jun. 12, 2008

(54) Trigger point therapy device

(76) Inventors: Gary Walquist, Boise, ID (US); Lynn Walquist, (US)

Correspondence Address: GARY WALQUIST, 2700 AGATE ST, BOISE, ID, 83705, US

(21) Appl. No.: 11/998,945

(22) Filed: Dec. 3, 2007

Related U.S. Application Data
(60) Provisional application No. 60/873,694, filed on Dec. 8, 2006.

(51) Int. Cl. A61H 7/00

(52) U.S. Cl. 601/134

(57) ABSTRACT

The trigger point therapy device is an effective pain management system based on trigger point therapy, a self-treatment method for pain relief. The trigger point therapy device provides a means to manually position the probe to an appropriate height specific to the body area needing trigger point treatment. The probe is manually moved upwardly and downwardly. The series of holes in the main post serve as receptors for the probe. The positioning device is mounted vertically to the wall with two mounting brackets. The present invention's design is simple and straightforward, and can be economically manufactured and can quickly and easily be set up.

### RELATED APPLICATIONS

The present application is a continuation-in-part application of U.S. provisional patent application Ser. No. 60/783,694, filed Dec. 8, 2006, for MECHANICAL TRIGGER POINT MASSAGE THERAPY DEVICE, by Gary Walquist (Boise, Id.), Lynn Walquist (Boise, Id.), included by reference herein and for which benefit of the priority date is hereby claimed.

### FIELD OF THE INVENTION

The present invention relates to a device that uses a natural pain management system based on trigger point therapy and, more particularly, a device used for self-applied trigger point therapy to relieve pain associated with contracted knots in the muscle tissue (trigger points).

### BACKGROUND OF THE INVENTION

This invention addresses the need for a safe, effective, and affordable self-applied trigger point therapy device.

A trigger point is a small contraction knot in the muscle tissue. To your finger tips it feels like a small lump and can range in size from a pin head to that of a walnut.

A trigger point affects a muscle by keeping it both tight and weak. A tight muscle keeps constant tension on the muscle's attachments producing symptoms in adjacent joints. This will cause limited range of motion of the muscle and compression of blood vessels and nerves causing such symptoms as headaches, neck and jaw pain, low back pain, carpal tunnel syndrome and many kinds of joint pain mistakenly ascribed to arthritis, tendinitis, bursitis, or ligament injury. Trigger points cause problems as diverse as earaches, dizziness, nausea, heartburn, false heart pain, heart arrhythmia, and tennis elbow and genital pain.

Self-applied trigger point therapy works by accomplishing three things: (1) it breaks into the chemical and neurological feedback loop that maintains the muscle contraction, (2) it increases circulation that has been restricted by the contracted tissue, (3) it directly stretches the trigger point's knotted muscle fibers.

The problems trigger points cause can be surprisingly easy to fix. Most people can to it themselves if they have the right tools.

Although professional therapy is available, no one can ever have the connection with your pain that you have. You know exactly where it hurts and how much it hurts. You know better than anyone else when a treatment feels right and when it doesn't. With self-treatment, you don't have to wait for an appointment and you can get help whenever you need it.

Other forms of trigger point therapy consist of; (1) pain medications that may have harmful side effects and don't really cure the cause of the pain, (2) surgery, expensive and has possible complications such as infection, often pain is not relieved, (3) TENS (Transcutaneous Electrical Nerve Stimulation) units, that merely mask pain, but have no effect on the cause of pain, (4) expensive injections administered by a physician with questionable results, (5) chiropractic and acupuncture procedures that are expensive and have limited success, (6) self-therapy, using your hands. This will cause straining and exhaust the muscles in the forearm and hands and could cause injuries to your hand and arm.

Considering the risks inherent in over working your hand, fingers and arm while doing self-applied therapy, it is smart to avoid using them if at all possible.

There are devices available used for self-applied trigger point therapy. One device uses a cane configuration. When using this product, it may put your arms and body in a compromising position causing stress and injury to another unrelated muscle within your body. Other devices use plastic and wooden instruments as extensions to a person's hand such as in the Knobble—U.S. Pat. No. 5,843,005. These also cause stress to the arm and shoulder muscle tissue.

### SUMMARY OF THE INVENTION

In accordance with the present invention, the trigger point therapy device is an effective pain management system based on trigger point therapy, a self-treatment method for pain relief. The trigger point therapy device provides a means to manually position the probe to an appropriate height specific to the body area needing trigger point treatment. The probe is manually moved upwardly and downwardly. The series of holes in the main post serve as receptors for the probe. The positioning device is mounted vertically to the wall with two mounting brackets. The present invention's design is simple and straightforward, and can be economically manufactured and can quickly and easily be set up.

It is therefore an object of the invention to provide an apparatus for self-applied trigger point therapy.

It is another object of the invention to provide the user with an apparatus for pain management associated with trigger points.

It is another object of the invention to provide a device superior to that is currently offered.

It is another object of the invention to make a simple and user friendly device that is affordable.

It is another object of the invention to provide a safe and effective trigger point pain management system.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front perspective view of a probe positioning device;

FIG. 2 is a front view of a probe;

FIG. 3 is a left perspective view of an user applying pressure on the trigger point;

FIG. 4 is a front perspective view of a numerical index system; and

FIG. 5 is a section view of a receptor holes in post.

For purposes of clarity and brevity, like elements and components will bear the same designations and numbering throughout the Figures.

### DESCRIPTION OF THE PREFERRED EMBODIMENT

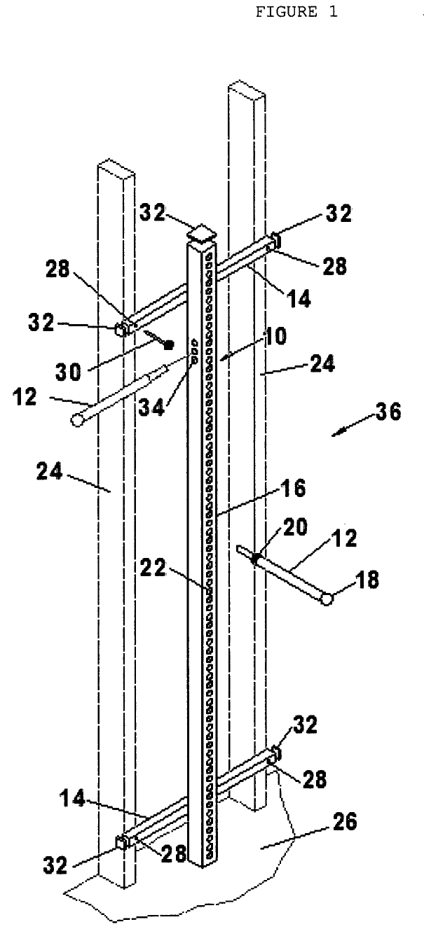

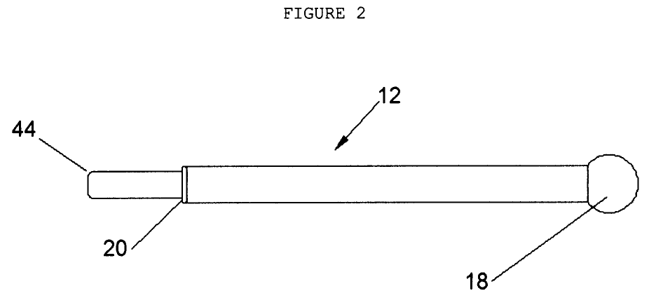

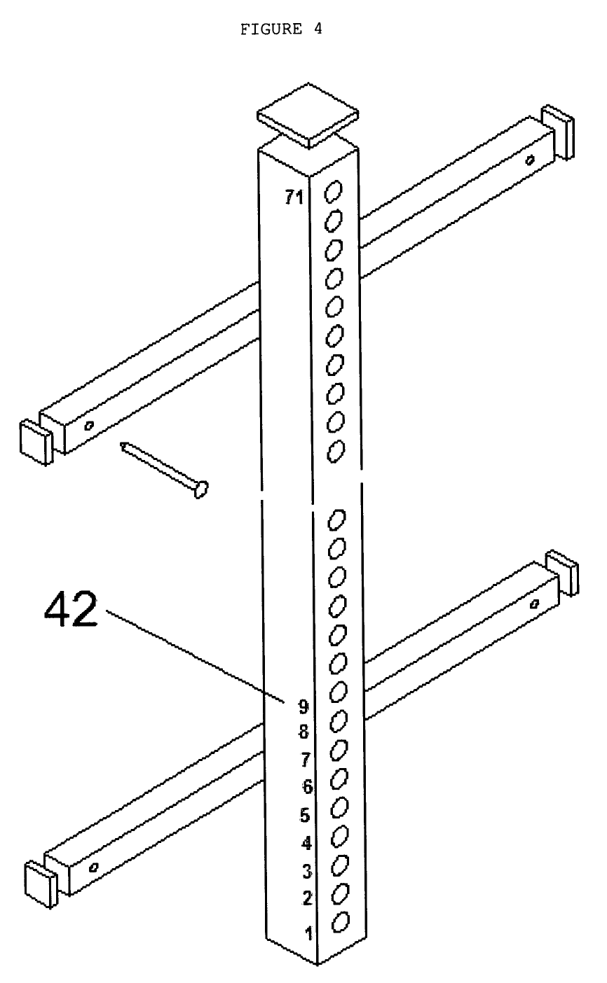

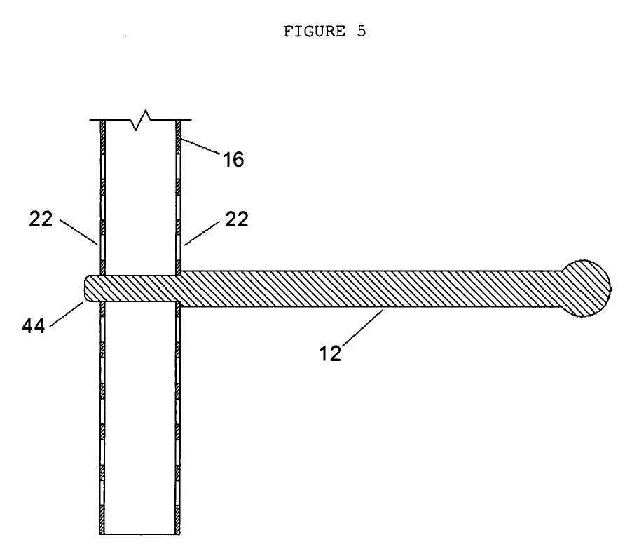

FIG. 1 is a front perspective of the trigger point therapy device 36. FIG. 2 is a front view of the probe 12. The probe positioning device 10 comprises an upper and lower mounting bracket 14 and a post 16. The post 16 is approximately 182.88 cm (72 inches) overall height. The base of the vertical post 16 rests on the floor 26. The mounting bracket 14 is approximately 45.72 mm (18 inches) overall width. The mounting bracket 14 comprises a right and left mounting hole 28 spaced 406.4 mm (16 inches) apart to match standard wall stud 24 spacing. The upper mounting bracket 14 is attached to the post 16 horizontally and centrally at approximately 152.4 mm (6 inches) from the top of the post 16. The lower mounting bracket 14 is attached to the post 16 horizontally and centrally at approximately 152.4 mm (6 inches) from the bottom of the post 16. The post 16 contains a receptor hole 22 spaced equally and centrally at 71 places in two opposing sides. Each receptor hole 22, FIG. 5, in opposite sides of the post 16 is approximately 15.875 mm (0.625 inches) diameter and vertically spaced at approximately 25.4 mm (1 inch) apart over the height of the post 16. Each storage receptor hole 34 is used to store the probe 12 flat against the wall when not in use. For cosmetic and safety reasons, a plastic end cap 32 is installed in the open ends of the mounting bracket 14 and the post 16. FIG. 4 illustrates the indexing scale 42 of the 71 receptor holes. The receptor hole 22 is numbered consecutively from 1 to 71 from the bottom of the vertical post 16. There are a number of methods to label the receptor hole 22 indexing scale 42, i.e. steel rule, punched, decals, etc.

FIG. 2 is a front perspective view of a probe 12. The length of the probe 12 is approximately 12 inches (304.8 mm) and comprises a rubber washer 20 and a detachable probe tip 18. One end of the probe 12 steps down from a ⅞ inch (22.225 mm) approximate diameter to ⅝ inch (15.875 mm) approximate diameter for a distance of approximately 2⅜ inches. The transition from the larger diameter to the smaller diameter creates a square shoulder where a rubber washer 20 is installed. On the opposite end of the probe 12 there is a detachable probe tip 18 used for user 40 contact. The axis of the probe 12 when in use has a perpendicular orientation to the vertical axis of the post 16 and is always normal to the plane of the wall. The leading and terminating edge of the small diameter of the probe 12 incorporates a fillet radius 44 for ease of inserting the probe 12 into the receptor hole 22. The probe tip 18 may have many shapes i.e. cylindrical, forked, etc. The probe tip 18 may be fabricated from a variety of materials i.e. stainless steel, rubber, plastic, composite material, etc.

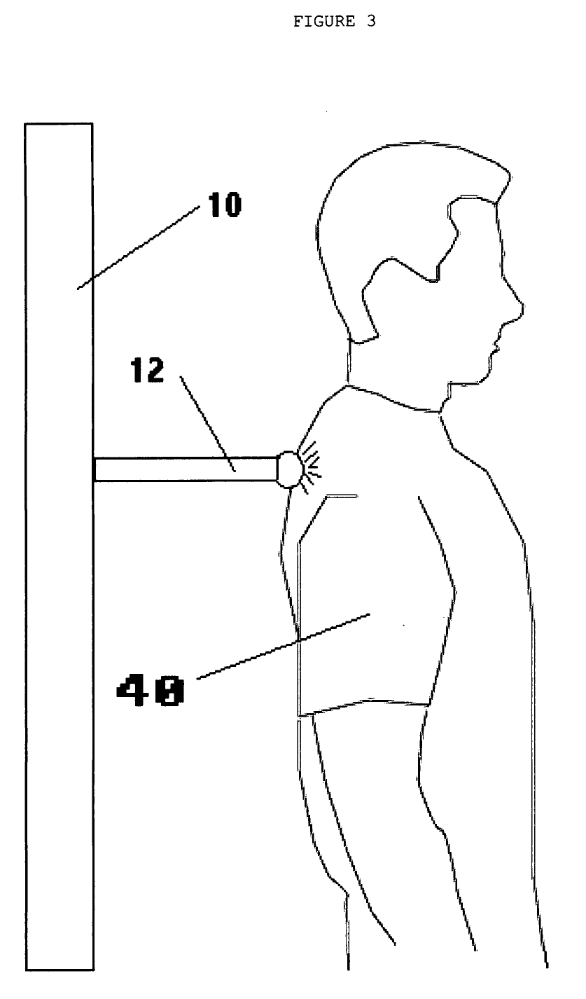

With further reference to FIG. 1, FIG. 2, and FIG. 3, when the self-applied trigger point therapy device 36 is used, the user 40 stands in front of the device and positions the probe 12 at the approximate height of the affected body area, then rotates his/her body until the affected area is in close proximity to the probe tip 18. At this point the user 40 leans into the probe 12 and uses the movement of the body to firmly stroke the affected area with the tip of the probe 12. This releases the trigger point after approximately 30 to 60 seconds returning the muscle tissue to normal function. With further reference to FIG. 4, indexing scale 42 is used to allow the user 40 to reference height of the probe 12 in subsequent therapy sessions. The trigger point therapy device 36 is mounted to the wall using an upper mounting bracket 14 and a lower mounting bracket 14 with screws 30.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A trigger point therapy device for a user to self-apply trigger point therapy, comprising:
means for vertically positioning the probe both upwardly and downwardly;
means for providing receptor holes for the probe;
means for self-applied trigger point therapy;
means for mounting the probe positioning device to the wall;
means for contacting the trigger point treatment area on the user;
means for cushioning the probe pressure;
means for accepting the probe;
means for providing a means for securing the bracket to the wall with screws;
means for storing probe flat against the wall when not in use;
means for user probe height reference; and
means for ease of probe insertion.

2. The trigger point therapy device in accordance with claim 1, wherein said means for vertically positioning the probe both upwardly and downwardly comprises a wall mounted probe positioning device.

3. The trigger point therapy device in accordance with claim 1, wherein said means for providing receptor holes for the probe comprises a square tubing, vertical, perforated post.

4. The trigger point therapy device in accordance with claim 1, wherein said means for self-applied trigger point therapy comprises a round, solid, rigid probe.

5. The trigger point therapy device in accordance with claim 1, wherein said means for mounting the probe positioning device to the wall comprises a horizontal, wall mounting bracket.

6. The trigger point therapy device in accordance with claim 1, wherein said means for contacting the trigger point treatment area on the user comprises a detachable, universal probe tip.

7. The trigger point therapy device in accordance with claim 1, wherein said means for cushioning the probe pressure comprises a rubber washer.

8. The trigger point therapy device in accordance with claim 1, wherein said means for accepting the probe comprises a receptor hole.

9. The trigger point therapy device in accordance with claim 1, wherein said means for providing a means for securing the bracket to the wall with screws comprises a mounting hole.

10. The trigger point therapy device in accordance with claim 1, wherein said means for storing probe flat against the wall when not in use comprises a storage receptor hole.

11. The trigger point therapy device in accordance with claim 1, wherein said means for user probe height reference comprises an indexing scale.

12. The trigger point therapy device in accordance with claim 1, wherein said means for ease of probe insertion comprises a fillet radius.

13. A trigger point therapy device for a user to self-apply trigger point therapy, comprising:
a wall mounted probe positioning device, for vertically positioning the probe both upwardly and downwardly;
a square tubing, vertical, perforated post, for providing receptor holes for the probe;
a round, solid, rigid probe, for self-applied trigger point therapy;
a horizontal, wall mounting bracket, for mounting the probe positioning device to the wall;
a detachable, universal probe tip, for contacting the trigger point treatment area on the user;
a rubber washer, for cushioning the probe pressure;
a receptor hole, for accepting the probe;
a mounting hole, for providing a means for securing the bracket to the wall with screws;
a storage receptor hole, for storing probe flat against the wall when not in use;
an indexing scale, for user probe height reference; and
a fillet radius, for ease of probe insertion.

14. The trigger point therapy device as recited in claim 13, further comprising:
a plastic end cap, for covering the end of tube openings.

15. A trigger point therapy device for a user to self-apply trigger point therapy, comprising:
a wall mounted probe positioning device, for vertically positioning the probe both upwardly and downwardly;
a square tubing, vertical, perforated post, for providing receptor holes for the probe;
a round, solid, rigid probe, for self-applied trigger point therapy;
a horizontal, wall mounting bracket, for mounting the probe positioning device to the wall;
a detachable, universal probe tip, for contacting the trigger point treatment area on the user;
a rubber washer, for cushioning the probe pressure;
a receptor hole, for accepting the probe;
a mounting hole, for providing a means for securing the bracket to the wall with screws;
a plastic end cap, for covering the end of tube openings;
a storage receptor hole, for storing probe flat against the wall when not in use;
an indexing scale, for user probe height reference; and
a fillet radius, for ease of probe insertion.
